(19) United States
(12) Patent Application Publication
(10) Pub. No.: US 2019/0341633 A1
(43) Pub. Date: Nov. 7, 2019

(54) INTEGRATED PLANAR CELL PATTERN TERMINATION FOR SUBSTRATE TUBE INTERCONNECTION

(71) Applicant: LG Fuel Cell Systems, Inc., North Canton, OH (US)

(72) Inventors: Richard Goettler, Medina, OH (US); Zhien Liu, Canal Fulton, OH (US); Charles Osborne, Akron, OH (US)

(73) Assignee: LG Fuel Cell Systems, Inc., North Canton, OH (US)

(21) Appl. No.: 15/971,821

(22) Filed: May 4, 2018

(51) Int. Cl. H01M 8/0252; H01M 8/2465; H01M 8/0236

(52) U.S. Cl. CPC H01M 8/0252; H01M 8/0236; H01M 8/2465

(57) ABSTRACT

A fuel cell tube comprises a substrate having a tube interconnect region and a fuel cell region, a plurality of fuel cells disposed on the fuel cell region, and a plurality of primary interconnects formed from an electrically conducting primary interconnect material forming electrically conducting paths between adjacent fuel cells to thereby electrically connect the fuel cells in series. The primary interconnect material extends from the fuel cell region into the tube interconnect region forming an electrically conducting path between the tube interconnect region and the plurality of fuel cells.

This invention was made with Government support under Assistance Agreement No. DE-FE0023337 awarded by Department of Energy. The Government has certain rights in this invention.

### FIELD

The present disclosure relates to fuel cell tubes and, more specifically, integrated planar cell pattern termination in tube interconnect regions.

### BACKGROUND

Tube interconnect regions are used to connect one fuel cell tube to another. Currently, screen patterns in the tube interconnect region result in a combination of printed layers at the ends of tubes consisting of porous anode barrier, dense barrier, electrolyte, cathode, cathode current collector, and tube interconnect bonding layers. During the application of the tube interconnect wire, additional inks are applied to bond the wire. One issue with the present practice is that the wide variety of materials in the tube interconnect region may lead to materials interactions causing phase changes and reaction products. Progression of reactivity over time can lead to increased electrical resistance, poor adhesion of the interconnection and potential fuel leakage, which poses a reliability risk by creating a localized hot spot and thermal stresses that could damage the ceramic fuel cell stack structure. The present disclosure mitigates the reliability issues with a primary interconnect material that extends from the fuel cell region into the tube interconnect region to reduce undesired materials interactions.

### SUMMARY

The present application discloses one or more of the features recited in the appended claims and/or the following features that, alone or in any combination, may comprise patentable subject matter.

According to an aspect of the present invention, a fuel cell tube comprises a substrate having a tube interconnect region and a fuel cell region, a plurality of fuel cells disposed on the fuel cell region, and a plurality of primary interconnects formed from an electrically conducting primary interconnect material forming electrically conducting paths between adjacent fuel cells to thereby electrically connect the fuel cells in series. The primary interconnect material extends from the fuel cell region into the tube interconnect region forming an electrically conducting path between the tube interconnect region and the plurality of fuel cells.

According to another aspect of the present disclosure, a fuel cell tube comprises a substrate having a tube interconnect region and a fuel cell region, a plurality of fuel cells disposed on the fuel cell region, and a plurality of primary interconnects formed from an electrically conducting primary interconnect material forming electrically conducting paths between adjacent fuel cells to thereby electrically connect the fuel cells in series. The fuel cell tube further comprises a first tube interconnect region at a first longitudinal end of the substrate and a second tube interconnect region at a second longitudinal end of the substrate. The fuel cell region extends between the first and second tube interconnect regions. The primary interconnect material extends into the first tube interconnect region at least in portions of the first tube interconnect region proximate the lateral ends of the substrate forming an electrically conducting path between the first tube interconnect region and the plurality of fuel cells. The primary interconnect material extends into the second tube interconnect region at least in portions of the second tube interconnect region proximate the lateral ends of the substrate forming an electrically conducting path between the second tube interconnect region and the plurality of fuel cells. A first central tube interconnect region is defined as the region between the portions of the first tube interconnect region proximate the lateral ends of the substrate, and an electrolyte material overlays at least the first central tube interconnect region. A second central tube interconnect region is defined as the region between the portions of the second tube interconnect region proximate the lateral ends of the substrate, and the electrolyte material overlays at least the second central tube interconnect region. The fuel cell tube further comprises a first tube interconnect wire electrically coupled to the primary interconnect material in the first tube interconnect region. The first tube interconnect wire is overlaid by a glass or glass-cermet material. The fuel cell tube further comprises a second tube interconnect wire electrically coupled to the primary interconnect material in the second tube interconnect region. The second tube interconnect wire is overlaid by a glass or glass-cermet material.

### BRIEF DESCRIPTION OF THE FIGURES

FIG. 1 is a simplified top view of an example fuel cell tube assembly in accordance with one embodiment of the present disclosure. FIG. 1 shows the fuel cell tube after the electrolyte print stage.

FIG. 2 is a simplified cross-sectional view of an example tube interconnect region along the width of the fuel cell tube in accordance with one embodiment of the present disclosure. FIG. 2 shows the fuel cell tube interconnect region after the cathode current collector print stage.

FIG. 3 is a simplified top view of an example fuel cell tube assembly in accordance with one embodiment of the present disclosure. FIG. 3 shows the fuel cell tube after the electrolyte print stage.

FIG. 4 is a simplified cross-sectional view of an example tube interconnect region along the width of the fuel cell tube in accordance with one embodiment of the present disclosure. FIG. 4 shows the fuel cell tube interconnect region after the cathode current collector print stage.

FIG. 5 is a simplified top view of an example fuel cell tube assembly in accordance with one embodiment of the present disclosure. FIG. 5 shows the fuel cell tube after the electrolyte print stage.

FIG. 6 is a simplified cross sectional view of an example tube interconnect region along the width of the fuel cell tube in accordance with one embodiment of the present disclosure. FIG. 6 shows the fuel cell tube interconnect region after the cathode current collector print stage.

FIG. 7 is a simplified top view of an example fuel cell tube assembly in accordance with one embodiment of the present disclosure. FIG. 7 shows the fuel cell tube after the electrolyte print stage.

FIG. 8 is a simplified cross sectional view of an example tube interconnect region along the width of the fuel cell tube in accordance with one embodiment of the present disclosure. FIG. 8 shows the fuel cell tube interconnect region after the cathode current collector print stage.

FIG. 9 is a simplified top view of an example fuel cell tube assembly in accordance with one embodiment of the present disclosure. FIG. 9 shows the fuel cell tube after the electrolyte print stage.

FIG. 10 is a simplified cross sectional view of another example tube interconnect region along the width of the fuel cell tube in accordance with one embodiment of the present disclosure. FIG. 10 shows the fuel cell tube interconnect region after the cathode current collector print stage.

While the present disclosure is susceptible to various modifications and alternative forms, specific embodiments have been shown by way of example in the drawings and will be described in detail herein. It should be understood, however, that the present disclosure is not intended to be limited to the particular forms disclosed. Rather, the present disclosure is to cover all modifications, equivalents, and alternatives falling within the spirit and scope of the disclosure as defined by the appended claims.

### DETAILED DESCRIPTION

While the features, methods, devices, and systems described herein may be embodied in various forms, the drawings show and the detailed description describes some exemplary and non-limiting embodiments. Not all of the components shown and described in the drawings and the detailed descriptions may be required, and some implementations may include additional, different, or fewer components from those expressly shown and described. Variations in the arrangement and type of the components; the shapes, sizes, and materials of the components; and the manners of attachment and connections of the components may be made without departing from the spirit or scope of the claims as set forth herein. This specification is intended to be taken as a whole and interpreted in accordance with the principles of the disclosure as taught herein and understood by one of ordinary skill in the art.

The apparatus described herein includes a fuel cell tube design that mitigates materials interactions in the tube interconnect region. Rather than have the tube printed patterns in the tube interconnect region terminate with cathode and cathode current collector layers to which glass-cermet inks are applied to adhere the tube-to-tube interconnection materials, the present disclosure involves the primary interconnect conductive material extending beyond the final fuel cell and into the tube interconnect current collection region. This allows for less material variability in the localized layers and avoids material incompatibility between LSM cathode and cathode current collector materials and glass present in conductive cermets and glass bonding layers to improve the wire attachment. Sufficient in-plane conductance is achieved to meet resistance specifications for the tube-to-tube interconnection.

It is possible that less material reactions and decomposition and the avoidance of the perovskite materials-glass interfaces in the high current density vicinity around the tube interconnect connection points will provide for improved durability of the active layers, including the integrity of underlying YSZ barrier layers to the fuel environment. The design described herein remains compatible with a range of designs for connecting opposing sides of the fuel cell tube, for the tube-to-tube connections, and for attachment of tertiary interconnects.

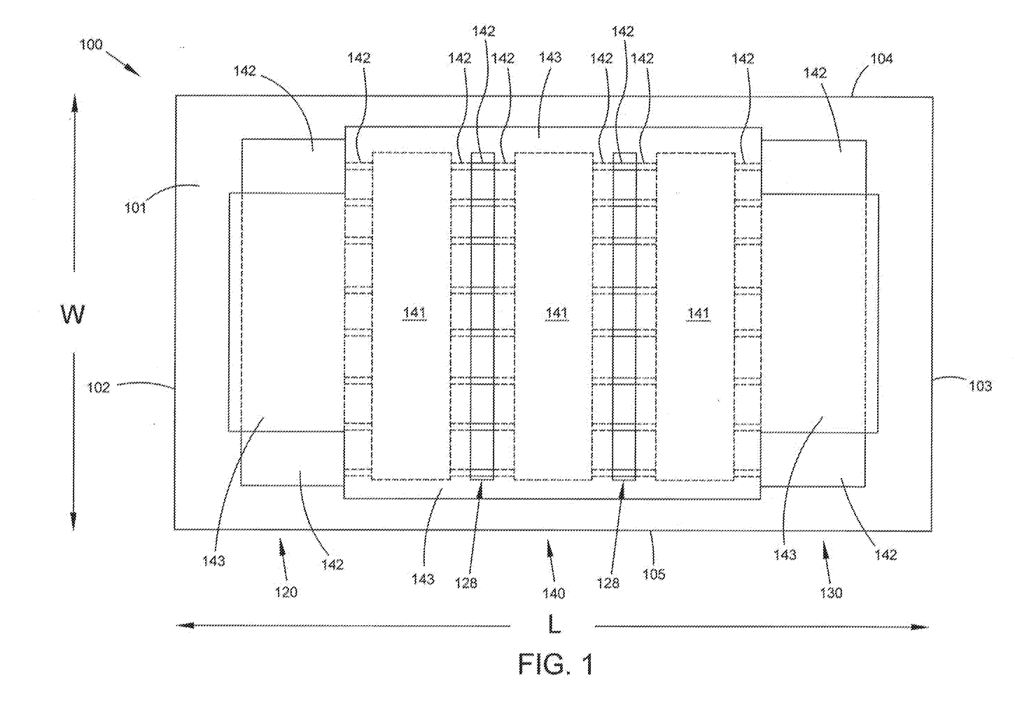

FIG. 1 illustrates a simplified top view of an example fuel cell tube 100 after the electrolyte print stage. Fuel cell tube 100 includes a substrate 101 with a first tube interconnect region 120 proximate first longitudinal end 102, a second tube interconnect region 130 proximate second longitudinal end 103, and a fuel cell region 140. Fuel cells 141 are disposed on the fuel cell region 140, and primary interconnects formed from primary interconnect material 142, which in this embodiment is an electrically conducting material, form electrically conducting paths between adjacent fuel cells 141 to electrically connect the fuel cells 141 in series. Electrolyte material 143 is printed in a pattern over the fuel cell region 140 and tube interconnect regions 120 and 130. In this embodiment, the electrolyte pattern includes windows 128, where electrolyte is not printed, in the fuel cell region 140. The fuel cells 141 and primary interconnect material 142 are represented by dashed lines when they are overlaid by electrolyte material 143.

In FIG. 1, the primary interconnect material 142 in fuel cell region 140 is shown as individual vias, but the primary interconnect material 142 may be vias or strip configurations. Spacing between the outer 1-3 vias (proximate lateral ends 104 and 105) can be altered from that of the rest of the tube to achieve the desired current near the end of the tube and to minimize the resistance associated with the tube-to-tube interconnection. The primary interconnect material 142 may be made of precious metal cermets, such as Pd—Pt—YSZ. The primary interconnect material 142 may also be made of cermets of platinum, palladium, or gold alloys with ceramic phases being a YSZ, alumina, pyrochlore, scandia stabilized zirconia, zircon, or spinel phases. In fuel cell region 140, fuel cells 141 are fully overlaid by electrolyte material 143, and the primary interconnect material 142 connecting fuel cells 141 is partially overlaid by electrolyte material 143. The primary interconnect material 142 is visible through the windows 128. The primary interconnect material 142 extends beyond a final fuel cell 141 proximate the first longitudinal end 102 in the fuel cell region 140 and into the first tube interconnect region 120. The primary interconnect material 142 forms an electrically conducting path between the first tube interconnect region 120 and fuel cells 141. The primary interconnect material 142 extends beyond a final fuel cell 141 proximate the second longitudinal end 103 in the fuel cell region 140 and into the second tube interconnect region 130. The length of the extended primary interconnect material 142 may be altered depending on the conductance of the material. The primary interconnect material 142 forms an electrically conducting path between the second tube interconnect region 130 and fuel cells 141.

An electrolyte material 143 overlays a central portion of the extended primary interconnect material 142 in both the first tube interconnect region 120 and the second tube interconnect region 130 in order to prevent precious metal material loss under long use. Portions of the primary interconnect material 142 are exposed (not overlaid by electrolyte or another such layer) in the first tube interconnect region 120 proximate lateral ends 104 and 105. Portions of the primary interconnect material 142 are exposed (not overlaid by electrolyte or another such layer) in the second tube interconnect region 130 proximate lateral ends 104 and 105. Tube interconnect wires or other components may be attached at the exposed portions of the primary interconnect material 142 in the first and second tube interconnect regions 120 and 130.

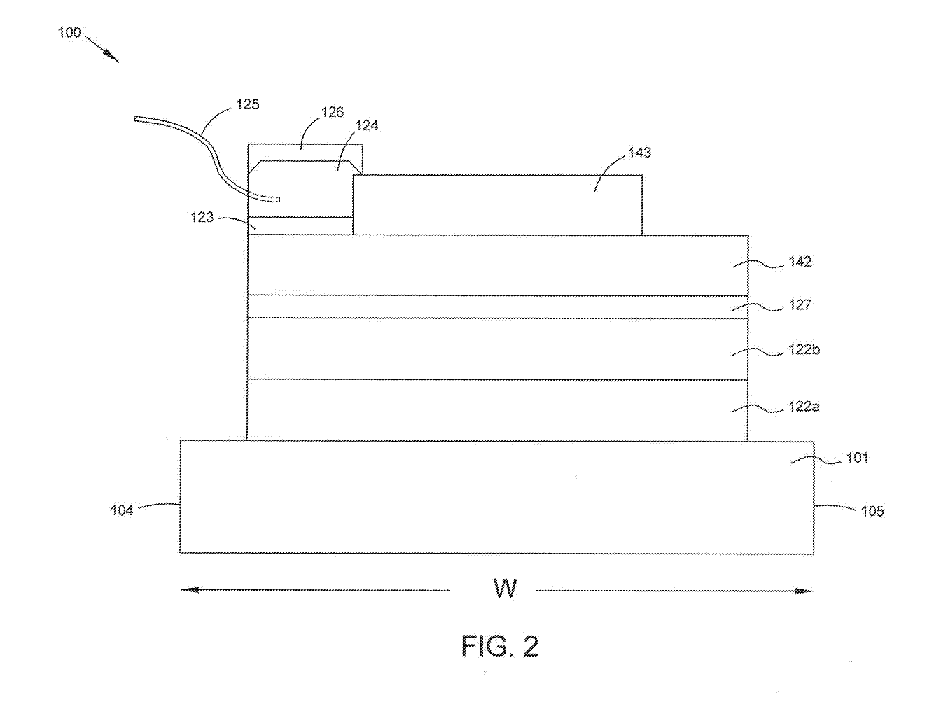

FIG. 2 illustrates a simplified cross-sectional view of a tube interconnect region 120 along the width of fuel cell tube 100 after a wire attachment has been made and after the cathode current collector print stage. Fuel cell tube 100 includes a substrate 101 with a tube interconnect region 120. The substrate 101 is overlaid by a porous anode barrier 122a in the tube interconnect region 120. Porous anode barrier 122a may be made of YSZ materials. Porous anode barrier 122a is overlaid by dense barrier 122b . The dense barrier 122b may be formed of any stabilized zirconia, zircon, pyrochlore, or any material that meets thermal expansion match, is sufficiently densified at processing conditions, is not an electronic conductor, and has limited ionic conductivity to avoid parasitic currents. One example of said material may be 8YSZ. In case of some ionic conductivity of the dense barrier 122b , an additional insulating layer 127 may be added, which would not require full densification for an air-fuel boundary, yet would provide a non-ionic and non-electronic conducting layer. Thus, the dense barrier 122b is overlaid by an optional additional electrical insulating layer 127 to prevent potential current-voltage drive degradation mechanisms of the underlying dense barrier 122b that must remain intact as a boundary between fuel and air. The electrical insulating layer 127 may be made of pyrochlores (La2Zr2O7), SrZrO3, MgAl2O4, Nb/Ta doped zirconia. The electrical insulating layer 127 is overlaid by primary interconnect material 142, which extends between first lateral end 104 and second lateral end 105. The primary interconnect material 142 may be made of precious metal cermets, such as Pd—Pt—YSZ. The primary interconnect material 142 may also be made of cermets of platinum, palladium, or gold alloys with ceramic phases being a YSZ, alumina, pyrochlore, scandia stabilized zirconia, zircon, or spinel phases. A central portion of the primary interconnect material 142 is overlaid by electrolyte material 143 while portions of the primary interconnect material 142 proximate lateral ends 104 and 105 are exposed (not overlaid by electrolyte). The exposed primary interconnect material 142 proximate lateral end 104 may be overlaid by ink trace 123, which is utilized for making the tube side-to-side interconnection. Ink trace 123 may be made of 45Glass-55Pd. A wire 125 is attached at the ink trace 123 with bond paste 124. The wire 125 may be made of Pd and the bond paste 124 may be made of precious metal glass based cermets, such as 45Glass-55Pd. The wire 125 and bond paste 124 are overlaid with glass 126 in order to help anchor the wire. The same attachment may be made at the exposed primary interconnect material 142 proximate the second lateral end 105. The same attachments may also be made in the second tube interconnect region 130.

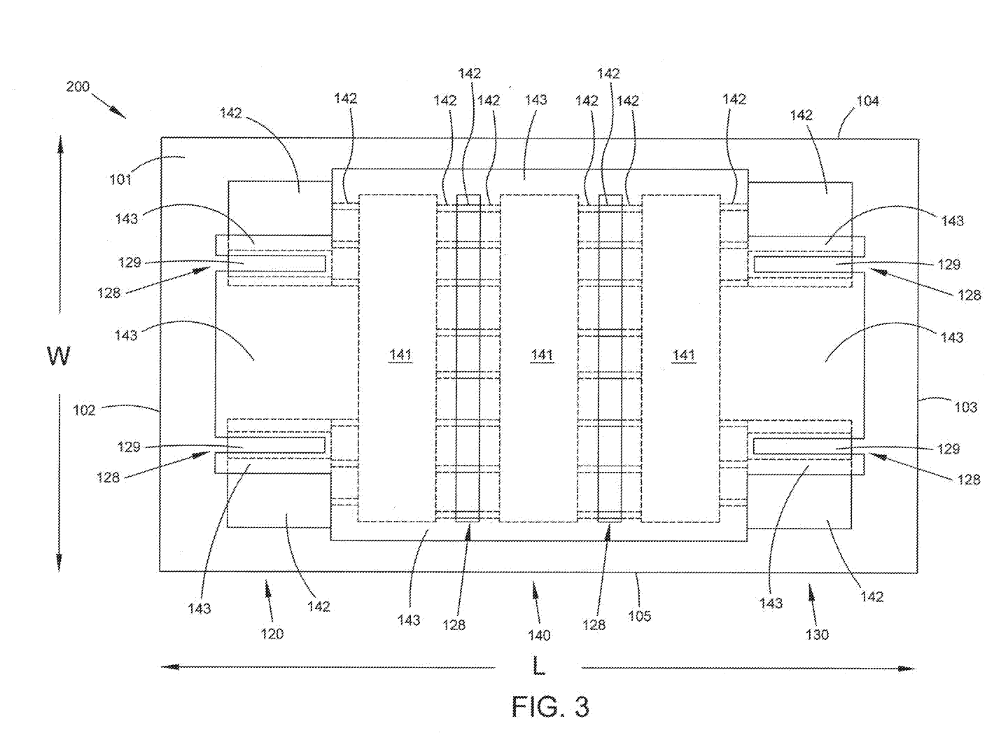

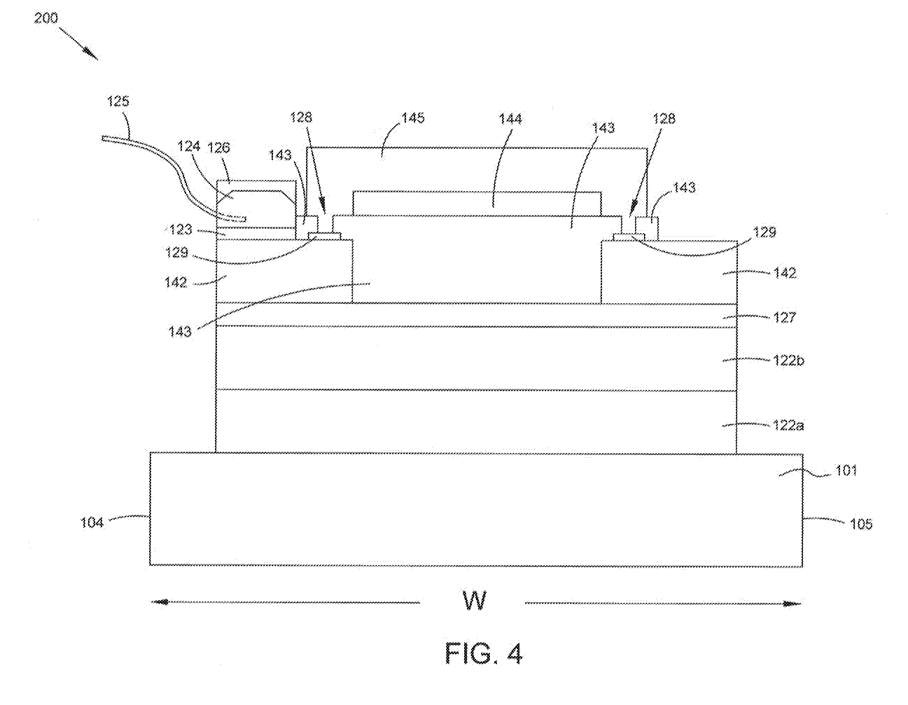

FIG. 3 illustrates a simplified top view of an example fuel cell tube 200 with windows 128 (as further described in FIG. 4) after the electrolyte print stage. The fuel cell tube includes a substrate 101 with a first tube interconnect region 120 proximate first longitudinal end 102, a second tube interconnect region 130 proximate second longitudinal end 103, and a fuel cell region 140. Fuel cells 141 are disposed on the fuel cell region 140, and primary interconnects formed from primary interconnect material 142, which in this embodiment is an electrically conducting material, form electrically conducting paths between adjacent fuel cells 141 to electrically connect the fuel cells 141 in series. Electrolyte material 143 is printed in a pattern over the fuel cell region 140 and tube interconnect regions 120 and 130. In this embodiment, the electrolyte pattern includes windows 128, where electrolyte is not printed, in the fuel cell region 140 and the tube interconnect regions 120 and 130. The fuel cells 141 and primary interconnect material 142 are represented by dashed lines when they are overlaid by electrolyte material 143.

In FIG. 3, the primary interconnects are shown as vias, but the primary interconnect material 142 may be vias or strip configurations. Spacing between the outer 1-3 vias (proximate lateral ends 104 and 105) can be altered from that of the rest of the tube to achieve the desired current near the end of the tube and to minimize the resistance associated with the tube-to-tube interconnection. The primary interconnect material may be made of precious metal cermets, such as Pd—Pt—YSZ. The primary interconnect material 142 may also be made of cermets of platinum, palladium, or gold alloys with ceramic phases being a YSZ, alumina, pyrochlore, scandia stabilized zirconia, zircon, or spinel phases. In fuel cell region 140, fuel cells 141 are fully overlaid by electrolyte material 143, and the primary interconnect material 142 connecting fuel cells 141 is partially overlaid by electrolyte material 143. The primary interconnect material 142 is visible through the windows 128 in the fuel cell region 140. The primary interconnect material 142 extends beyond a final fuel cell 141 proximate the first longitudinal end 102 in the fuel cell region 140 and into the first tube interconnect region 120 only in areas proximate lateral ends 104 and 105. The primary interconnect material 142 forms an electrically conducting path between the first tube interconnect region 120 and fuel cells 141. The primary interconnect material 142 extends beyond a final fuel cell 141 proximate the second longitudinal end 103 in the fuel cell region 140 and into the second tube interconnect region 130 only in areas proximate lateral ends 104 and 105. The primary interconnect material 142 forms an electrically conducting path between the second tube interconnect region 130 and fuel cells 141. The length of the extended primary interconnect material 142 may be altered depending on the conductance of the material.

An electrolyte material 143 overlays a central portion of both the first tube interconnect region 120 and the second tube interconnect region 130 and partially overlays the extended primary interconnect material 142 proximate each lateral end. The electrolyte material 143 includes windows 128, where electrolyte is not printed, to allow for electrical connection between the cathode current collector 145 (not shown) overlaying the windows and the extended primary interconnect material 142 proximate each lateral end. Protective barrier 129 is visible through windows 128 in tube interconnect regions 120 and 130. The windows 128 avoid the potential interaction of the glass in the tube interconnect wire bond materials and LSM of the cathode current collector 145. Portions of the primary interconnect material 142 are exposed (not overlaid by electrolyte or cathode current collector) in the first tube interconnect region 120 proximate lateral ends 104 and 105. Portions of the primary interconnect material 142 are exposed (not overlaid by electrolyte or cathode current collector) in the second tube interconnect region 130 proximate lateral ends 104 and 105. Tube interconnect wires or other components may be attached at the exposed portions of the primary interconnect material 142 in the first and second tube interconnect regions 120 and 130. The target minimum electrolyte frame between the extended primary interconnect material 142 and the cathode current collector 145 (not shown) is 1.5 mm in the tube interconnect regions 120 and 130 for adequate space to avoid cathode current collector contact with the glass used to attach interconnect wires or other components. This embodiment minimizes the amount of additional precious metal cermet of the primary interconnect material 142 in the tube interconnect regions.

FIG. 4 illustrates a simplified cross-sectional view of a tube interconnect region 120 along the width of the fuel cell tube 200 after a wire attachment has been made and after the cathode current collector print stage. Fuel cell tube 200 includes a substrate 101 with a tube interconnect region 120. The substrate 101 is overlaid by a porous anode barrier 122a in the tube interconnect region 120. Porous anode barrier 122a may be made of YSZ materials. Porous anode barrier 122a is overlaid by dense barrier 122b . The dense barrier 122b may be formed of any stabilized zirconia, zircon, pyrochlore, or any material that meets thermal expansion match, is sufficiently densified at processing conditions, is not an electronic conductor, and has limited ionic conductivity to avoid parasitic currents. One example of said material may be 8YSZ. In case of some ionic conductivity of the dense barrier 122b , an additional insulating layer 127 may be added, which would not require full densification for an air-fuel boundary, yet would provide a non-ionic and non-electronic conducting layer. Thus, the dense barrier 122b is overlaid by an optional additional electrical insulating layer 127 to prevent potential current-voltage drive degradation mechanisms of the underlying dense barrier 122b that must remain intact as a boundary between fuel and air. The electrical insulating layer 127 may be made of pyrochlores (La2Zr2O7), SrZrO3, MgAl2O4, Nb/Ta doped zirconia.

The electrical insulating layer 127 is overlaid by primary interconnect material 142 in areas proximate lateral ends 104 and 105, and a central tube interconnect region is defined as the region between the portions of the tube interconnect region proximate the lateral ends 104 and 105 of the substrate 101. Electrolyte material 143 fully overlays the exposed (not overlaid by primary interconnect material) electrical insulating layer 127 in the central tube interconnect region and partially overlays the primary interconnect material 142 in areas proximate the lateral ends. The primary interconnect material 142 may be made of precious metal cermets, such as Pd—Pt—YSZ. The primary interconnect material 142 may also be made of cermets of platinum, palladium, or gold alloys with ceramic phases being a YSZ, alumina, pyrochlore, scandia stabilized zirconia, zircon, or spinel phases. Electrolyte material 143 is overlaid by cathode 144 and cathode current collector 145. Electrolyte material 143 includes windows 128, where electrolyte is not printed, that allow for electrical connection between the cathode current collector 145 and the primary interconnect material 142, which provides lateral current flow. Protective barrier 129 overlays the primary interconnect material 142 within the windows 128, separating the primary interconnect material 142 from the cathode current collector material 145. Protective barrier 129 may be formed of a material suitable to prevent volatility of any precious metals over long-term operation.

The exposed (not overlaid by electrolyte or protective barrier) primary interconnect material 142 proximate the first lateral end 104 may be overlaid by ink trace 123, which is utilized for making the tube side-to-side interconnection. Ink trace 123 may be made of 45Glass-55Pd. A wire 125 is attached at the ink trace 123 with a bond paste 124. The wire 125 may be made of Pd and the bond paste 124 may be made of precious metal glass based cermets, such as 45Glass-55Pd. The wire 125 and bond paste 124 are overlaid with glass 126 in order to help anchor the wire. The same attachment may be made at the exposed primary interconnect material 142 proximate the second lateral end 105. The same attachments may also be made in tube interconnect region 130. Windows 128 in the tube interconnect regions 120 and 130 avoid the potential interaction and material incompatibility between the glass and LSM of the cathode current collector 145, while relying primarily on the conductance of the cathode and CCC layers for in-plane conductance in the interconnection region rather than precious metal cermets.

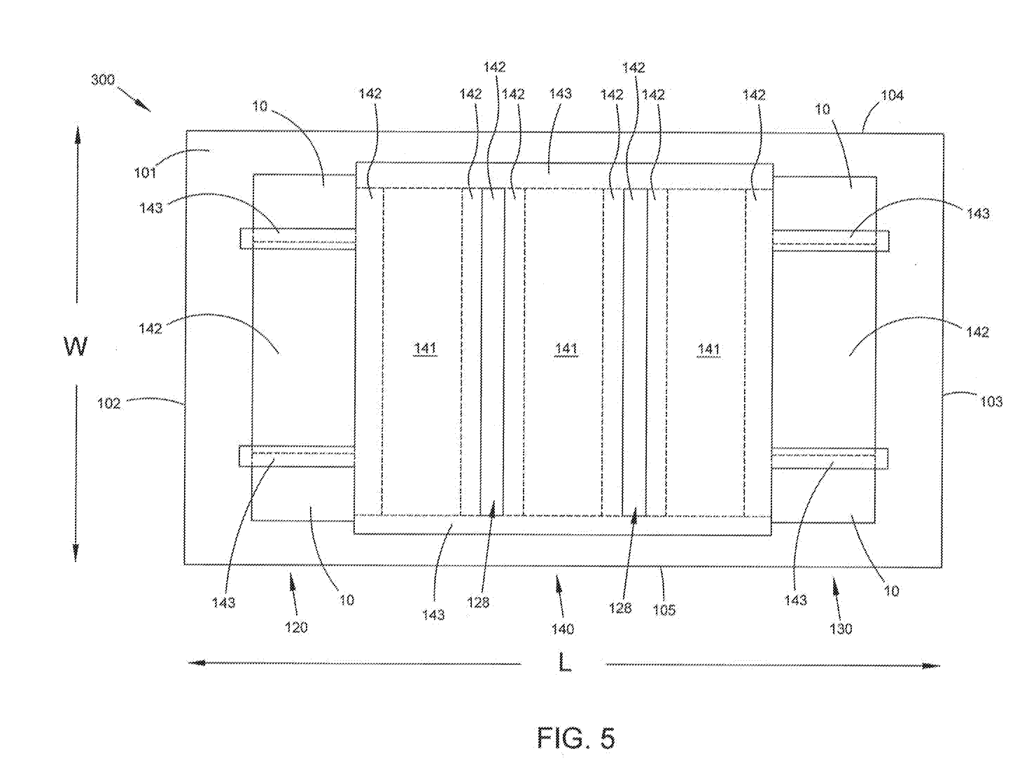

FIG. 5 illustrates a simplified top view of an example fuel cell tube 300 after the electrolyte print stage. Fuel cell tube 300 includes a substrate 101 with a first tube interconnect region 120 proximate first longitudinal end 102, a second tube interconnect region 130 proximate second longitudinal end 103, and a fuel cell region 140. Fuel cells 141 are disposed on the fuel cell region 140, and primary interconnects formed from primary interconnect material 142, which in this embodiment is made from a low conductance ceramic, form electrically conducting paths between adjacent fuel cells 141 to electrically connect the fuel cells 141 in series. Electrolyte material 143 is printed in a pattern over the fuel cell region 140 and tube interconnect regions 120 and 130. This pattern includes windows 128, where electrolyte is not printed, in the fuel cell region 140. Strips of the primary interconnect material 142 are visible through the windows 128 in the fuel cell region 140. The fuel cells 141, primary interconnect material 142, and precious metal cermet pads 10 are represented by dashed lines when they are overlaid by electrolyte material 143.

The low conductance ceramic primary interconnect material 142 has sufficient conductance for the small distance between adjacent fuel cells 141. In this embodiment, the primary interconnects may be strip configurations. In a strip configuration, the primary interconnect material 142 extends the full width of the fuel cells 141. In fuel cell region 140, fuel cells 141 are fully overlaid by electrolyte material 143, and the primary interconnect material 142 connecting fuel cells 141 is partially overlaid by electrolyte material 143. The primary interconnect material 142 is visible through windows 128 in the fuel cell region 140. The primary interconnect material 142 extends beyond a final fuel cell 141 proximate the first longitudinal end 102 in the fuel cell region 140 and into the first tube interconnect region 120. The length of the extended primary interconnect material 142 can be altered depending on the material's conductance. The primary interconnect material 142 forms an electrically conducting path between the first tube interconnect region 120 and fuel cells 141. The primary interconnect material 142 extends beyond a final fuel cell 141 proximate the second longitudinal end 103 in the fuel cell region 140 and into the second tube interconnect region 130. The length of the extended primary interconnect material 142 can be altered depending on the conductance of the material. The primary interconnect material 142 forms an electrically conducting path between the second tube interconnect region 130 and fuel cells 141.

Precious metal cermet pads 10 extend between the primary interconnect material 142 and the lateral ends 104 and 105 in the tube interconnect regions 120 and 130. The purpose of precious metal cermet pads 10 is to provide a similar material set for bonding the precious metal wires and glass-cermet bond pastes to and avoiding contact between glass and perovskite materials typical of cathode, cathode current collectors and ceramic interconnects which would exhibit unwanted material interactions. A cathode current collector 145 (not shown) overlays the primary interconnect material 142 in order to support in plane conductance in the tube interconnect region. Tube interconnect wires or other components may be attached at the precious metal cermet pads 10 in the first and second tube interconnect regions 120 and 130. An electrolyte material 143 extends into first and second tube interconnect regions 120 and 130 to separate the cathode current collector 145 (not shown) and primary interconnect material 142 from the tube interconnect bonding materials (not shown) in both the first tube interconnect region 120 and the second tube interconnect region 130. The electrolyte material 143 that extends into the tube interconnect regions 120 and 130 partially overlays the precious metal cermet pads 10 and the primary interconnect material 142.

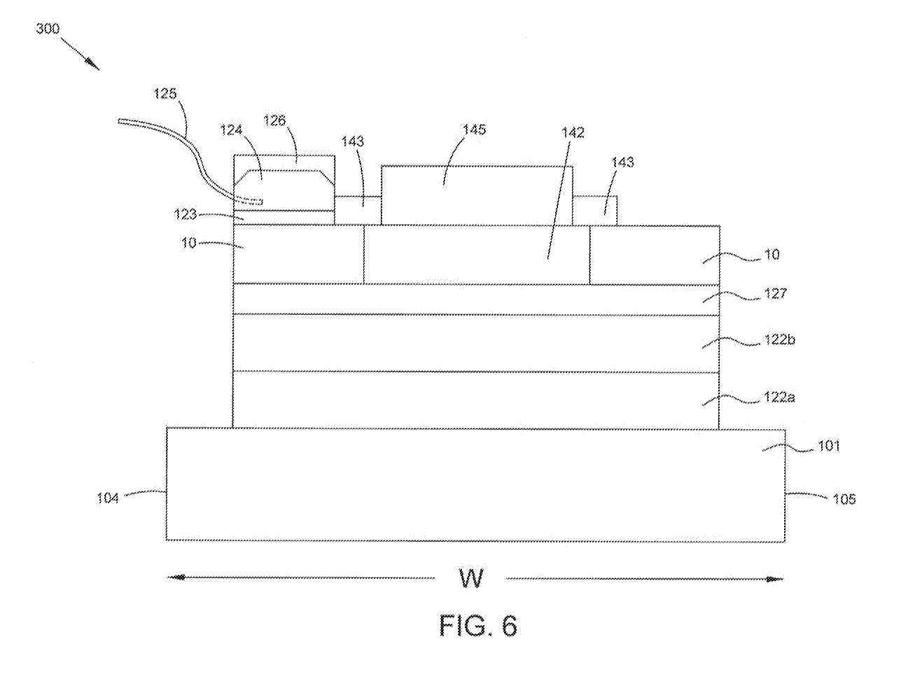

FIG. 6 illustrates a simplified cross-sectional view of a tube interconnect region 120 along the width of fuel cell tube 300 after a wire attachment has been made and after the cathode current collector print stage. Fuel cell tube 300 includes a substrate 101 with a tube interconnect region 120. The substrate 101 is overlaid by a porous anode barrier 122a in the tube interconnect region 120. Porous anode barrier 122a may be made of YSZ materials. Porous anode barrier 122a is overlaid by dense barrier 122b . The dense barrier 122b may be formed of any stabilized zirconia, zircon, pyrochlore, or any material that meets thermal expansion match, is sufficiently densified at processing conditions, is not an electronic conductor, and has limited ionic conductivity to avoid parasitic currents. One example of said material may be 8YSZ. In case of some ionic conductivity of the dense barrier 122b , an additional insulating layer 127 may be added, which would not require full densification for an air-fuel boundary, yet would provide a non-ionic and non-electronic conducting layer. Thus, the dense barrier 122b is overlaid by an optional additional electrical insulating layer 127 to prevent potential current-voltage drive degradation mechanisms of the underlying dense barrier 122b that must remain intact as a boundary between fuel and air. The electrical insulating layer 127 may be made of pyrochlores (La2Zr2O7), SrZrO3, MgAl2O4, Nb/Ta doped zirconia.

The electrical insulating layer 127 is overlaid by primary interconnect material 142, which extends longitudinally from the fuel cell region 140 (not shown) through the tube interconnect region 120 and laterally across the central portion of the tube interconnect region 120. The primary interconnect material 142 may be made of a low conductance ceramic that has sufficient conductance for the small distance between adjacent fuel cells 141. Precious metal cermet pads 10 overlay electrical insulating layer 127 in areas proximate the first and second lateral ends 104 and 105 for tube interconnect attachments in order to prevent glass used in the attachments from reacting with the low conductance ceramic primary interconnect material 142 and cathode current collector 145. Cathode current collector 145 overlays the primary interconnect material 142, and electrolyte material 143 separates the cathode current collector 145 from areas proximate the lateral ends 104 and 105 where a tube interconnect wire or other components may be attached. Optionally, a cathode (not shown) could overlay primary interconnect material 142 and the cathode current collector 145 would overlay the cathode.

The exposed (not overlaid by electrolyte) precious metal cermet pad 10 proximate the first lateral end 104 may be overlaid by ink trace 123, which is utilized for making the tube side-to-side interconnection. Ink trace 123 may be made of 45Glass-55Pd. A wire 125 is attached at the ink trace 123 with a bond paste 124. The wire 125 may be made of Pd and the bond paste 124 may be made of precious metal glass based cermets, such as 45Glass-55Pd. The wire 125 and bond paste 124 are overlaid with glass 126 in order to help anchor the wire. The same attachment may be made at the precious metal cermet pad 10 proximate the second lateral end 105. The same attachments may also be made in tube interconnect region 130. Electrolyte material 143 in tube interconnect regions 120 and 130 avoids the potential interaction and material incompatibility between the glass and LSM of the cathode current collector 145. This embodiment could achieve a good balance in cost reduction versus performance.

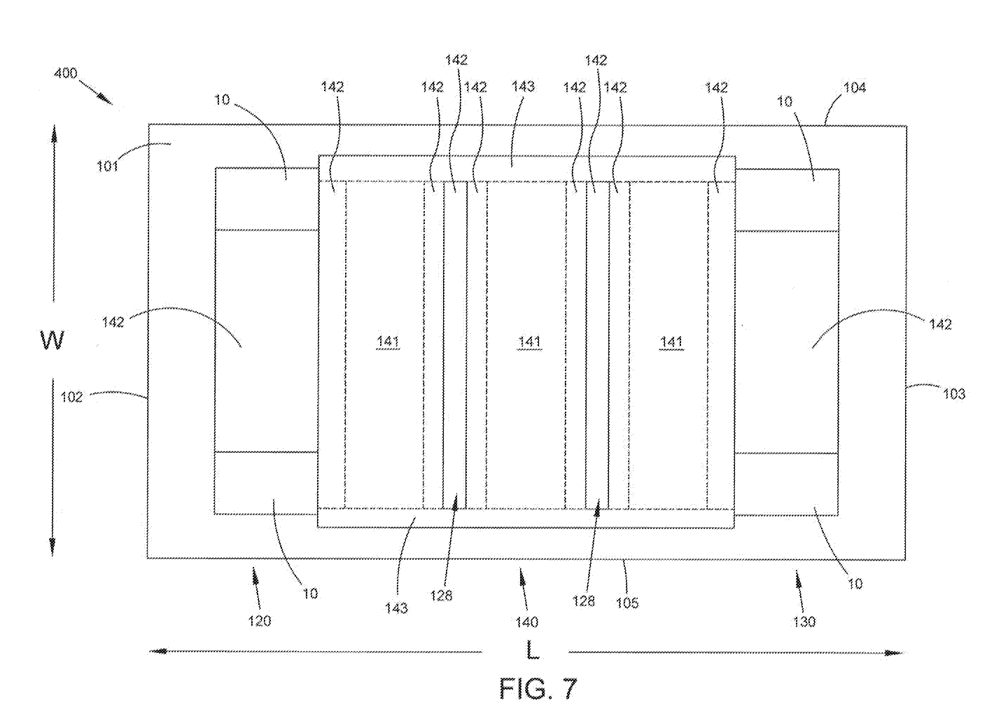

FIG. 7 illustrates a simplified top view of an example fuel cell tube 400 after the electrolyte print stage. Fuel cell tube 400 includes a substrate 101 with a first tube interconnect region 120 proximate first longitudinal end 102, a second tube interconnect region 130 proximate second longitudinal end 103, and a fuel cell region 140. Fuel cells 141 are disposed on the fuel cell region 140, and primary interconnects formed from primary interconnect material 142, which in this embodiment is made from a low conductance ceramic, form electrically conducting paths between adjacent fuel cells 141 to electrically connect the fuel cells 141 in series. Electrolyte material 143 is printed in a pattern over the fuel cell region 140. This pattern includes windows 128, where electrolyte is not printed, in the fuel cell region 140. Strips of the primary interconnect material 142 are visible through these windows 128 in the fuel cell region 140. The fuel cells 141 and primary interconnect material 142 are represented by dashed lines when they are overlaid by electrolyte material 143.

The low conductance ceramic primary interconnect material 142 has sufficient conductance for the small distance between adjacent fuel cells 141. In this embodiment, the primary interconnects may be strip configurations. In a strip configuration, the primary interconnect material 142 extends the full width of the fuel cells 141. In fuel cell region 140, fuel cells 141 are fully overlaid by electrolyte material 143, and the primary interconnect material 142 connecting fuel cells 141 is partially overlaid by electrolyte material 143. The primary interconnect material 142 is visible through windows 128 in the fuel cell region 140. The primary interconnect material 142 extends beyond a final fuel cell 141 proximate the first longitudinal end 102 in the fuel cell region 140 and into the first tube interconnect region 120. The length of the extended primary interconnect material 142 may be altered depending on the material's conductance. The primary interconnect material 142 forms an electrically conducting path between the first tube interconnect region 120 and fuel cells 141. The primary interconnect material 142 extends beyond a final fuel cell 141 proximate the second longitudinal end 103 in the fuel cell region 140 and into the second tube interconnect region 130. The length of the extended primary interconnect material 142 can be altered depending on the conductance of the material. The primary interconnect material 142 forms an electrically conducting path between the second tube interconnect region 130 and fuel cells 141.

Precious metal cermet pads 10 extend between the primary interconnect material 142 and the lateral ends 104 and 105 in the tube interconnect regions 120 and 130. The purpose of precious metal cermet pads 10 is to provide a similar material set for bonding the precious metal wires and glass-cermet bond pastes to and avoiding contact between glass and perovskite materials typical of cathode, cathode current collectors and ceramic interconnects which would exhibit unwanted material interactions. A cathode current collector 145 (not shown) overlays the primary interconnect material 142 in order to support in plane conductance in the tube interconnect region. Tube interconnect wires or other components may be attached at the precious metal cermet pads 10 in the first and second tube interconnect regions 120 and 130. An electrolyte layer in the tube interconnect regions may not be required for an embodiment in which the ceramic primary interconnect material 142 does not react adversely with glass.

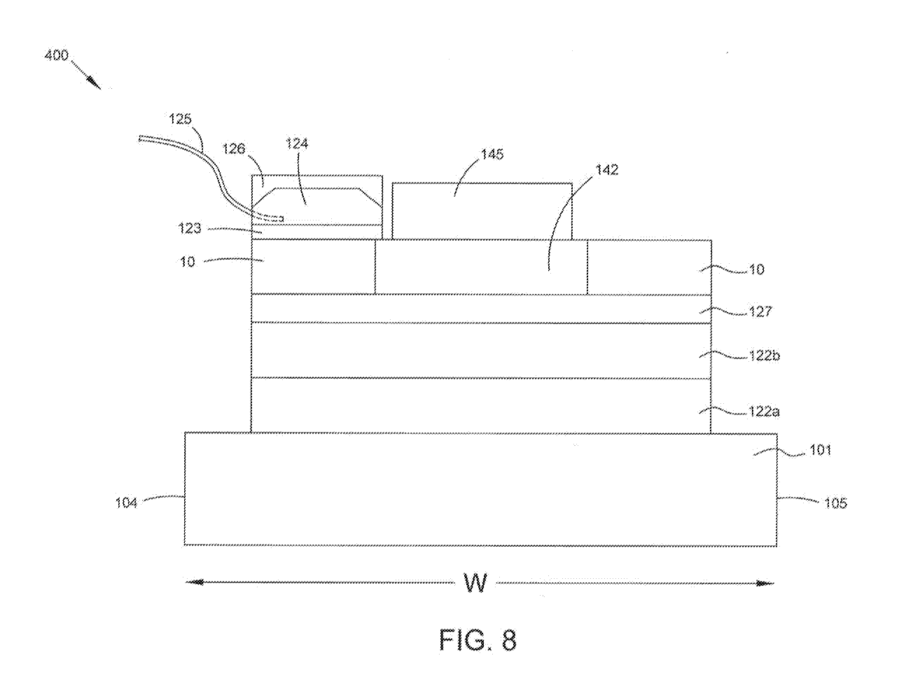

FIG. 8 illustrates a simplified cross-sectional view of a tube interconnect region 120 along the width of the fuel cell tube 400 after a wire attachment has been made and after the cathode current collector print stage. Fuel cell tube 400 includes a substrate 101 with a tube interconnect region 120. The substrate 101 is overlaid by a porous anode barrier 122a in the tube interconnect region 120. Porous anode barrier 122a may be made of YSZ materials. Porous anode barrier 122a is overlaid by dense barrier 122b . The dense barrier 122b may be formed of any stabilized zirconia, zircon, pyrochlore, or any material that meets thermal expansion match, is sufficiently densified at processing conditions, is not an electronic conductor, and has limited ionic conductivity to avoid parasitic currents. One example of said material may be 8YSZ. In case of some ionic conductivity of the dense barrier 122b , an additional insulating layer 127 may be added, which would not require full densification for an air-fuel boundary, yet would provide a non-ionic and non-electronic conducting layer. Thus, the dense barrier 122b is overlaid by an optional additional electrical insulating layer 127 to prevent potential current-voltage drive degradation mechanisms of the underlying dense barrier 122b that must remain intact as a boundary between fuel and air. The electrical insulating layer 127 may be made of pyrochlores (La2Zr2O7), SrZrO3, MgAl2O4, Nb/Ta doped zirconia.

The electrical insulating layer 127 is overlaid by primary interconnect material 142, which extends longitudinally from the fuel cell region 140 (not shown) through the tube interconnect region 120 and laterally across the central portion of the tube interconnect region 120. The primary interconnect material 142 may be made of a low conductance ceramic which does not react adversely with glass and has sufficient conductance for the small distance between adjacent fuel cells 141. Precious metal cermet pads 10 overlay electrical insulating layer 127 in areas proximate the first and second lateral ends 104 and 105 for tube interconnect attachments. Cathode current collector 145 overlays the primary interconnect material 142 and is laterally spaced from lateral ends 104 and 105. Optionally, a cathode (not shown) may overlay primary interconnect material 142 and the cathode current collector 145 may overlay the cathode. Tube interconnect wires or other components may be attached at the precious metal cermet pads proximate lateral end 104 or 105. An electrolyte layer may not be required for the embodiment in which the ceramic primary interconnect material 142 does not react adversely with glass.

The precious metal cermet pad 10 proximate the first lateral end 104 may be overlaid by ink trace 123, which is utilized for making the tube side-to-side interconnection. Ink trace 123 may be made of 45Glass-55Pd. A wire 125 is attached at the ink trace 123 with a bond paste 124. The wire 125 may be made of Pd and the bond paste 124 may be made of precious metal glass based cermets, such as 45Glass-55Pd. The wire 125 and bond paste 124 are overlaid with glass 126 in order to help anchor the wire. The same attachment may be made at the precious metal cermet pad 10 proximate the second lateral end 105. The same attachments may also be made in tube interconnect region 130.

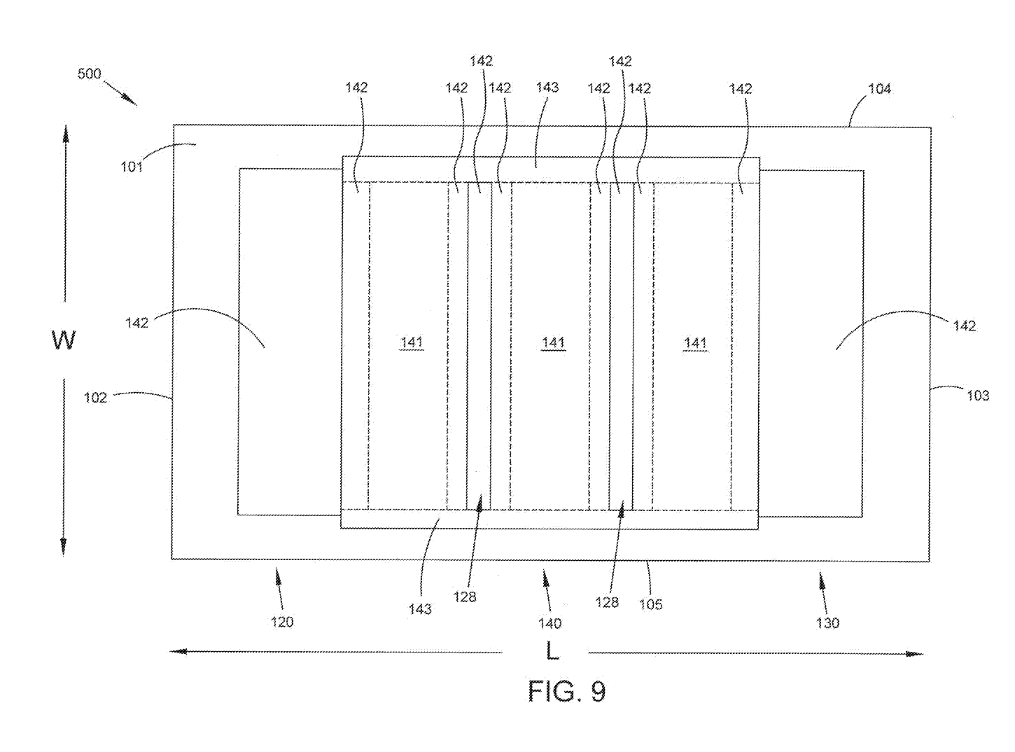

FIG. 9 illustrates a simplified top view of an example fuel cell tube 500 after the electrolyte print stage. Fuel cell tube 500 includes a substrate 101 with a first tube interconnect region 120 proximate first longitudinal end 102, a second tube interconnect region 130 proximate second longitudinal end 103, and a fuel cell region 140. Fuel cells 141 are disposed on the fuel cell region 140, and primary interconnects formed from primary interconnect material 142, which in this embodiment is made from a low conductance ceramic, form electrically conducting paths between adjacent fuel cells 141 to electrically connect the fuel cells 141 in series. Electrolyte material 143 is printed in a pattern over the fuel cell region 140. This pattern includes windows 128, where electrolyte is not printed, in the fuel cell region 140. Strips of the primary interconnect material 142 are visible through these windows 128 in the fuel cell region 140. The fuel cells 141 and primary interconnect material 142 are represented by dashed lines when they are overlaid by electrolyte material 143.

The low conductance ceramic primary interconnect material 142 has sufficient conductance for the small distance between adjacent fuel cells 141. In this embodiment, the primary interconnects may be strip configurations. In a strip configuration, the primary interconnect material 142 extends the full width of the fuel cells 141. In fuel cell region 140, fuel cells 141 are fully overlaid by electrolyte material 143, and the primary interconnect material 142 connecting fuel cells 141 is partially overlaid by electrolyte material 143. The primary interconnect material 142 is visible through windows 128 in the fuel cell region 140. The primary interconnect material 142 extends beyond a final fuel cell 141 proximate the first longitudinal end 102 in the fuel cell region 140 and into the first tube interconnect region 120. The length of the extended primary interconnect material 142 can be altered depending on the conductance of the material. The primary interconnect material 142 forms an electrically conducting path between the first tube interconnect region 120 and fuel cells 141. The primary interconnect material 142 extends beyond a final fuel cell 141 proximate the second longitudinal end 103 in the fuel cell region 140 and into the second tube interconnect region 130. The length of the extended primary interconnect material 142 can be altered depending on the conductance of the material. The primary interconnect material 142 forms an electrically conducting path between the second tube interconnect region 130 and fuel cells 141.

The primary interconnect material 142 in the tube interconnect regions 120 and 130 extends between the lateral ends 104 and 105. A cathode current collector 145 (not shown) overlays the primary interconnect material 142 in tube interconnect regions 120 and 130 in order to support in plane conductance in the tube interconnect region. Tube interconnect wires or other components may be attached at the cathode current collector 145 (not shown) in the first and second tube interconnect regions 120 and 130.

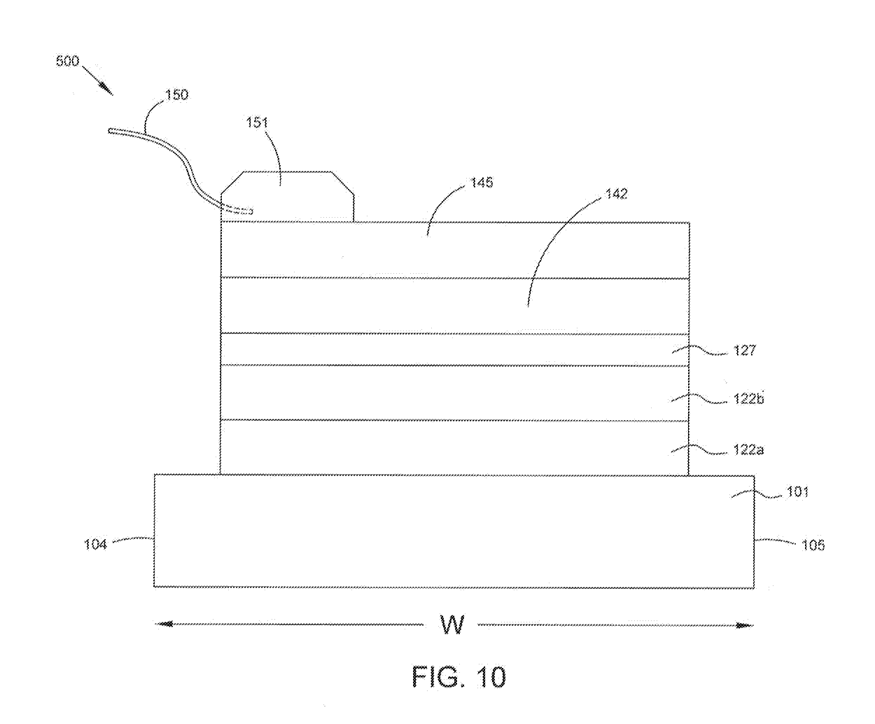

FIG. 10 illustrates a simplified cross-sectional view of a tube interconnect region 120 along the width of the fuel cell tube 500 after a wire attachment has been made and after the cathode current collector print stage. Fuel cell tube 500 includes a substrate 101 with a tube interconnect region 120. The substrate 101 is overlaid by a porous anode barrier 122a in the tube interconnect region 120. Porous anode barrier 122a may be made of YSZ materials. Porous anode barrier 122a is overlaid by dense barrier 122b . The dense barrier 122b may be formed of any stabilized zirconia, zircon, pyrochlore, or any material that meets thermal expansion match, is sufficiently densified at processing conditions, is not an electronic conductor, and has limited ionic conductivity to avoid parasitic currents. One example of said material may be 8YSZ. In case of some ionic conductivity of the dense barrier 122b , an additional insulating layer 127 may be added, which would not require full densification for an air-fuel boundary, yet would provide a non-ionic and non-electronic conducting layer. Thus, the dense barrier 122b is overlaid by an optional additional electrical insulating layer 127 to prevent potential current-voltage drive degradation mechanisms of the underlying dense barrier 122b that must remain intact as a boundary between fuel and air. The electrical insulating layer 127 may be made of pyrochlores (La2Zr2O7), SrZrO3, MgAl2O4, Nb/Ta doped zirconia.

The electrical insulating layer 127 is overlaid by primary interconnect material 142, which extends longitudinally from the fuel cell region 140 (not shown) through the tube interconnect region 120 and laterally across the tube interconnect region 120. The primary interconnect material 142 may be made of a low conductance ceramic that has sufficient conductance for the small distance between adjacent fuel cells 141. Cathode current collector 145 overlays the primary interconnect material 142 and extends laterally across the tube interconnect region 120. Optionally, a cathode (not shown) could overlay primary interconnect material 142 and the cathode current collector 145 would overlay the cathode. Tube interconnect wires or other components may be attached at the cathode current collector 145 proximate lateral end 104 or 105.

The wire 150 is made from a non-precious metal. Wire 150 is attached at the cathode current collector 145 proximate the first lateral end 104. The wire 150 is attached using a bond paste 151, which may be a ceramic paste absent precious metals. This embodiment would not address tube side-to-side connections and as such would not include an ink trace. The same attachment may be made at the cathode current collector 145 proximate the second lateral end 105. The same attachments may also be made in tube interconnect region 130.

Various modifications to the embodiments described herein will be apparent to those skilled in the art. These modifications can be made without departing from the spirit and scope of the present disclosure and without diminishing its intended advantages. It is intended that such changes and modifications be covered by the appended claims.

1. A fuel cell tube comprising a substrate having a tube interconnect region and a fuel cell region, a plurality of fuel cells disposed on the fuel cell region, and a plurality of primary interconnects formed from an electrically conducting primary interconnect material forming electrically conducting paths between adjacent fuel cells to thereby electrically connect the fuel cells in series,
wherein the primary interconnect material extends from the fuel cell region into the tube interconnect region forming an electrically conducting path between the tube interconnect region and the plurality of fuel cells.

2. The fuel cell tube of claim 1 comprising a first tube interconnect region at a first longitudinal end of the substrate and a second tube interconnect region at a second longitudinal end of the substrate and the fuel cell region extending between the first and second tube interconnect regions, wherein the primary interconnect material extends into the first tube interconnect region forming an electrically conducting path between the first tube interconnect region and the plurality of fuel cells.

3. The fuel cell tube of claim 2 wherein the primary interconnect material extends into the second tube interconnect region forming an electrically conducting path between the second tube interconnect region and the plurality of fuel cells.

4. The fuel cell tube of claim 1 wherein a portion of the primary interconnect material extending into the tube interconnect region is overlaid by an electrolyte material.

5. The fuel cell tube of claim 4 wherein said substrate comprises a first and second lateral end, said tube interconnect region extends between said lateral ends.

6. The fuel cell tube of claim 5 wherein the electrolyte material does not extend into the tube interconnect region proximate said lateral ends.

7. The fuel cell tube of claim 1 comprising layers of a dense barrier material and a porous anode barrier material extending into the tube interconnect region, wherein the primary interconnect material overlays at least a portion of said layers in the tube interconnect region.

8. The fuel cell tube of claim 7 comprising a tube interconnect wire electrically coupled to the primary interconnect material in the tube interconnect region and overlaid by a glass or glass-cermet material.

9. The fuel cell tube of claim 7 comprising an electrical insulating layer extending into the tube interconnect region, wherein said electrical insulating layer is positioned between at least a portion of the primary interconnect material and the dense barrier material layer.

10. The fuel cell tube of claim 9 wherein the electrical insulating layer is one of a pyrochlore, SrZrO₃, MgAl₂O₄, and Nb/Ta doped zirconia.

11. The fuel cell tube of claim 7 wherein the dense barrier material layer comprises stabilized zirconia.

12. The fuel cell tube of claim 1 wherein the primary interconnect material comprises one or more of cermets of platinum, palladium, or gold alloys with ceramic phases being a YSZ, alumina, pyrochlore, scandia stabilized zirconia, zircon, or spinel phases.

13. The fuel cell tube of claim 5 wherein the primary interconnect material extends from the fuel cell region into the tube interconnect region only in portions of the tube interconnect region proximate the lateral ends of the substrate.

14. The fuel cell tube of claim 13 wherein a central tube interconnect region is defined as the region between the portions of the tube interconnect region proximate the lateral ends of the substrate, and wherein the electrolyte material fully overlays the central tube interconnect region and partially overlays the primary interconnect material extending into the tube interconnect region.

15. The fuel cell tube of claim 14 comprising a cathode current collector layer overlaying at least a portion of the electrolyte material in the tube interconnect region.

16. The fuel cell tube of claim 15 comprising a protective barrier extending into the tube interconnect region, wherein said protective barrier is positioned between at least a portion of the cathode current collector layer and the primary interconnect material.

17. The fuel cell tube of claim 1 wherein the primary interconnect material is a low conductance ceramic.

18. The fuel cell tube of claim 17 comprising a precious metal cermet material in the tube interconnect region, and said precious metal cermet being positioned adjacent a point proximate each lateral end of the substrate.

19. A fuel cell tube comprising:
a substrate having a tube interconnect region and a fuel cell region, a plurality of fuel cells disposed on the fuel cell region, and a plurality of primary interconnects formed from an electrically conducting primary interconnect material forming electrically conducting paths between adjacent fuel cells to thereby electrically connect the fuel cells in series;
a first tube interconnect region at a first longitudinal end of the substrate and a second tube interconnect region at a second longitudinal end of the substrate and the fuel cell region extending between the first and second tube interconnect regions,
wherein the primary interconnect material extends into the first tube interconnect region at least in portions of the first tube interconnect region proximate the lateral ends of the substrate forming an electrically conducting path between the first tube interconnect region and the plurality of fuel cells,
wherein the primary interconnect material extends into the second tube interconnect region at least in portions of the second tube interconnect region proximate the lateral ends of the substrate forming an electrically conducting path between the second tube interconnect region and the plurality of fuel cells,
wherein a first central tube interconnect region is defined as the region between the portions of the first tube interconnect region proximate the lateral ends of the substrate, and wherein an electrolyte material overlays at least the first central tube interconnect region,
wherein a second central tube interconnect region is defined as the region between the portions of the second tube interconnect region proximate the lateral ends of the substrate, and wherein the electrolyte material overlays at least the second central tube interconnect region;
a first tube interconnect wire electrically coupled to the primary interconnect material in the first tube interconnect region and overlaid by a first glass or glass-cermet material;
a second tube interconnect wire electrically coupled to the primary interconnect material in the second tube interconnect region and overlaid by a second glass or glass-cermet material.
